(19) United States
(12) Patent Application Publication
(10) Pub. No.: US 2018/0031020 A1
(43) Pub. Date: Feb. 1, 2018

(54) JOINING DEVICE AND ASSEMBLED STRUCTURE HAVING THE SAME

(71) Applicants: Ping-Kun CHEN, Tokyo (JP); Chang-Teng LIN, Taichung (CN); Shang-Ting CHEN, Taichung (CN)

(72) Inventors: Ping-Kun CHEN, Tokyo (JP); Chang-Teng LIN, Taichung (CN); Shang-Ting CHEN, Taichung (CN)

(21) Appl. No.: 15/660,636

(22) Filed: Jul. 26, 2017

(30) Foreign Application Priority Data
Jul. 27, 2016 (JP) 2016-147650

(51) Int. Cl. F16B 12/20; F16B 5/06; F16B 5/07; F16B 5/02

(52) U.S. Cl. CPC F16B 12/20; F16B 5/0258; F16B 5/0607; F16B 5/07

(57) ABSTRACT

A joining device includes a male member having a shaft portion, and a tubular female member having a mating portion whereto the shaft portion is inserted and fitted, which are capable of detachably joined with each other. The shaft portion includes, on an outer surface thereof and along an axial line direction, a plurality of protruded portions about an axial line of the shaft portion in a cross section taken along an axial line direction and protruded over an entire perimeter. The mating portion includes, on an inner surface thereof and along an axial line direction, a plurality of recessed portions about an axial line of the mating portion in a cross section taken along an axial line direction and recessed over an entire perimeter. The shaft portion and the mating portion are joined by being engaged at the protruded portions and the recessed portions.

### CROSS REFERENCE TO RELATED APPLICATIONS

This application claims the benefit of Japanese Patent Application No. 2016-147650, filed Jul. 27, 2016, which is hereby incorporated by reference in its entirety.

### BACKGROUND

### Technical Field

The present disclosure relates to a joining device and an assembled structure having the same, and particularly relates to a joining device used in assembling boards of ready-to-assemble furniture with each other and an assembled structure that is assembled using such a joining device.

### Background

In the related art, ready-to-assemble furniture is known that is assembled into various forms by joining a plurality of boards in any combination. For example, when assembling ready-to-assemble furniture, such as shelf, a frame is formed with a top board, a base board, and right and left side boards, and a back board is attached to this frame, and further, a plurality of shelf boards are attached inside the frame. Here, a joining device that joins the top board, the base board, the side boards, the back board and the shelf boards with each other may be a screw.

However, a large force is required for joining the boards with each other by screwing a screw with a screw-driver while placing the boards on top of each other, and thus it is not an easy task to perform for women and elderly people. Also, when a screwing direction of a screw into the board is deviated, the screw may protrude from the board, and break the board.

Accordingly, in order to couple a plurality of boards, a coupling structure is known that couples a plurality of boards with each other without using tools such as a screw-driver, by pushing a joint member incorporated in one board, i.e., a male member, into an engaging member incorporated in another board, i.e., a female member, (e.g., see Japanese Patent No. 5719485).

A coupling structure described in Japanese Patent No. 5719485 is provided with a male member which is a rod-like member of a certain length and a hollow female member. An outer surface of the male member is provided with a joint member engagement portion wherein locking portions having concentric crests and troughs are continuously formed. The locking portion has a first inclined surface formed at a predetermined angle with respect to a longitudinal direction of the male member, and a second inclined surface formed approximately perpendicular to the longitudinal direction of the male member. On an inner surface of the female member, a plurality of hooks are formed.

When the male member is inserted into the female member, the locking portion is locked to the hooks of the female member, and the male member and the female member come to a mated state.

According to Japanese Patent No. 5719485, once the male member and the female member are mated, the mated state between the locking portion of the male member and the hooks of the female member is not released unless they are destroyed. Therefore, in a case where boards have been attached to each other in an incorrect combination or in a case where one wants to disassemble and move the furniture to another place, it is necessary to destroy the locking portion of the male member and the hooks of the female member to release the joined state between the boards.

The present disclosure is related to providing a joining device that enables joining and releasing of a male member and a female member, as well as an assembled structure having the same.

### SUMMARY

According to an aspect of the present disclosure, a joining device comprises a male member including a shaft portion and a female member including a mating portion whereto the shaft portion is inserted and fitted, the female member having a bottomed tubular shape, the male member and the female member being capable of being detachably joined with each other, the shaft portion including a plurality of protruded portions on an outer surface thereof along an axial line direction and a slit at a tip portion in a direction of insertion into the mating portion, each protruded portion of the plurality of protruded portions having an arc shape in a cross section taken along the axial line direction and being protruded over an entire perimeter about an axial line of the shaft portion, the slit lying along the axial line, the mating portion having a plurality of recessed portions on an inner surface thereof along an axial line direction and a bottom portion configured to close the mating portion, each recessed portion of the plurality of recessed portions having an arc shape in a cross section taken along the axial line direction and being recessed over an entire perimeter about an axial line of the mating portion, the bottom portion having a rod-like projected portion projecting in a direction opposite to the direction of insertion and capable of being inserted into the slit, the slit having a length that divides the protruded portion provided on a side of the tip portion of the shaft portion along the axial line direction, the projected portion having a length that reaches the recessed portion provided at a position closest to the bottom portion among the plurality of recessed portions, wherein the shaft portion and the mating portion are capable of being joined by being engaged at the plurality of protruded portions and the plurality of recessed portions, an interference fit being created between the slit and the projected portion.

Preferably, the plurality of protruded portions are spaced apart from each other in the axial line direction of the shaft portion by a predetermined interval, and the plurality of recessed portions are spaced apart from each other in the axial line direction of the mating portion by a predetermined interval.

Also, preferably, the projected portion has a columnar portion formed integrally with the bottom portion and creating an interference fit with the slit, and a tapered portion formed integrally on a tip side of the columnar portion.

According to another aspect of the present disclosure, an assembled structure comprises a first assembly component, a second assembly component, and a male member including a shaft portion and a female member including an mating portion whereto the shaft portion is inserted and fitted, the male member and the female member being capable of being detachably joined with each other, the first and second assembly components being capable of being assembled by being joined with each other, the shaft portion including a plurality of protruded portions on an outer surface thereof along an axial line direction and a slit at a tip portion in a direction of insertion into the mating portion, each protruded portion of the plurality of protruded portions having an arc shape in a cross section taken along the axial line direction and being protruded over an entire perimeter about an axial line of the shaft portion, the slit lying along the axial line, the mating portion having a plurality of recessed portions on an inner surface thereof along an axial line direction and a bottom portion configured to close the mating portion, each recessed portion of the plurality of recessed portions having an arc shape in a cross section taken along a direction of the axial line and recessed over an entire perimeter about an axial line of the mating portion, the bottom portion having a rod-like projected portion projecting in a direction opposite to the direction of insertion and capable of being inserted into the slit, the slit having a length that divides the protruded portion provided on a side of the tip portion side of the shaft portion along the axial line direction, the projected portion having a length that reaches the recessed portion provided at a position closest to the bottom portion among the plurality of recessed portions, the female member being attached to one of the first assembly component and the second assembly component, the male member being attached to one of the second assembly component and the first assembly component, the first and second assembly components being joined with each other by engagement of the shaft portion of the male member and the mating portion of the female member at the plurality of protruded portions and the plurality of recessed portions, an interference fit being created between the slit and the projected portion.

According to the present disclosure, a male member and a female member can be joined and released.

### BRIEF DESCRIPTION OF DRAWINGS

FIG. 1 is a diagram illustrating a joining device according to a first embodiment.

FIG. 2 is a side elevation of a male member of the joining device according to the first embodiment.

FIG. 3A is a perspective view showing a female member of the joining device according to the first embodiment.

FIG. 3B is a cross-sectional view showing a female member of the joining device according to the first embodiment taken along an axial line of the female member.

FIG. 4 is a diagram showing a state where a tip portion of the male member is inserted into the female member.

FIG. 5 is a diagram showing a state where the male member is partially engaged with the female member.

FIG. 6 is a diagram showing a state where the male member and the female member are completely joined.

FIG. 7 is a side elevation of a male member of a joining device according to a second embodiment.

FIG. 8A is a schematic perspective view of an assembled structure including joining devices according to the first and second embodiments.

FIG. 8B is a cross-sectional view of an assembled structure including joining devices according to the first and second embodiments taken along line I-I in FIG. 8A.

FIG. 9A is an explanatory diagram of a joining operation using the joining device according to the first embodiment showing a state before joining.

FIG. 9B is an explanatory diagram of a joining operation using the joining device according to the first embodiment showing a state after joining.

FIG. 10A is an explanatory diagram of a joining operation using the joining device according to the second embodiment showing a state before joining.

FIG. 10B is an explanatory diagram of a joining operation using the joining device according to the second embodiment showing a state after joining.

### DETAILED DESCRIPTION

Further features of the present disclosure will become apparent from the following detailed description of exemplary embodiments with reference to the accompanying drawings. Note that embodiments described below are given by way of example, and may be of various configurations within the scope of the present disclosure.

### First Embodiment

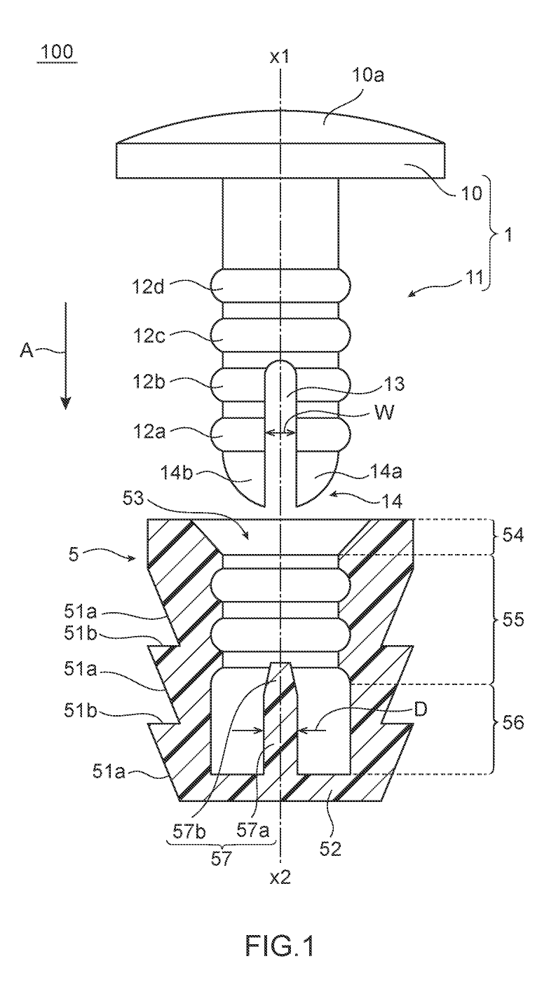

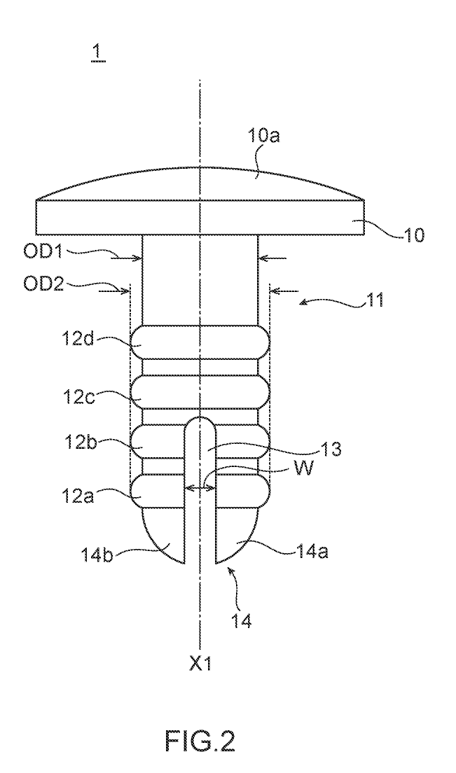

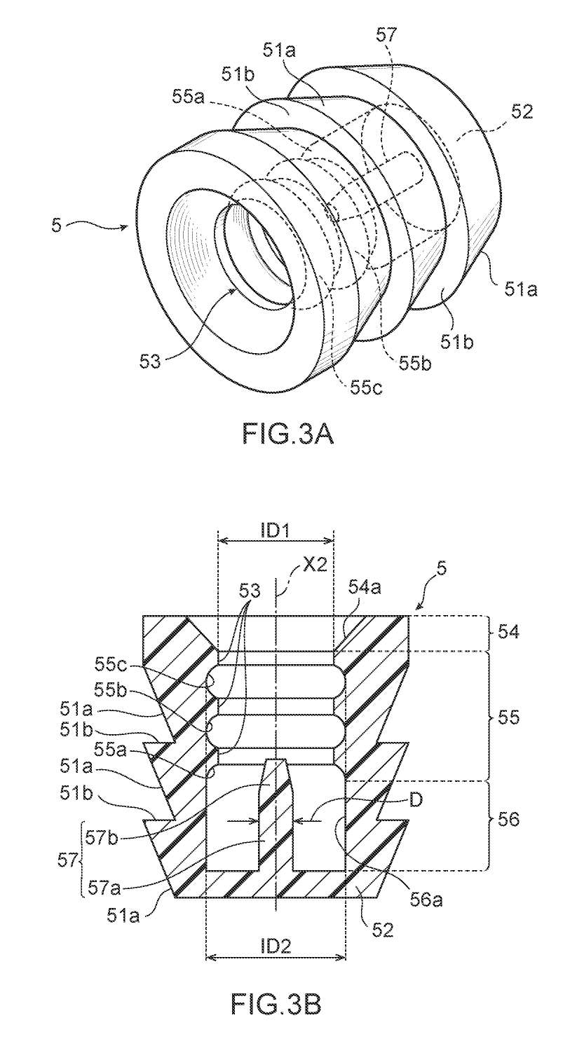

FIG. 1 is a diagram illustrating a joining device according to a first embodiment. FIG. 2 is a side elevation of a male member of the joining device according to the first embodiment. FIG. 3A is a perspective view showing a female member of the joining device according to the first embodiment. FIG. 3B is a cross-sectional view showing a female member of the joining device according to the first embodiment taken along an axial line of the female member.

### [Joining Device]

As shown in FIG. 1, a joining device 100 includes a male member 1 and a female member 5. The joining device 100 is, for example, used in combining and joining a plurality of boards of ready-to-assemble furniture. The male member 1 and the female member 5 may be made of, for example, a synthetic resin such as nylon, a metallic material or wood, but the material is not particularly limited.

(Male Member)

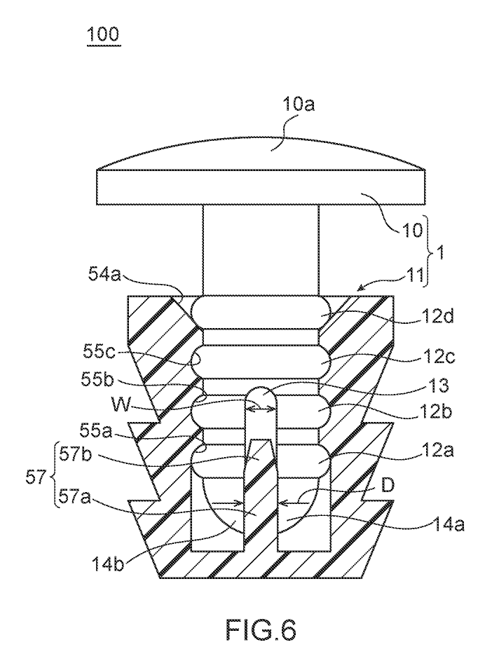

The male member 1 is configured to be joined to the female member 5 by being inserted therein and fitted therewith (see FIG. 6). As shown in FIG. 2, the male member 1 includes a head portion 10 and a shaft portion 11 that is formed integrally with the head portion 10.

The head portion 10 is a portion having a circular shape in a plan view, and has a diameter greater than that of the shaft portion 11. The head portion 10 has a spherical surface portion 10a that is formed spherically bulging outwardly at a side opposite to the shaft portion 11. The spherical surface portion 10a serves as a contact surface that is pushed down when the male member 1 is inserted towards the female member 5 by a finger of the operator.

The shaft portion 11 is a columnar portion that is to be engaged with the female member 5 by being inserted and fitted thereto. A tip portion 14 of the shaft portion 11 is formed in a curved shape (a dome shape).

The shaft portion 11 has a plurality of protruded portions 12a to 12d bulging in an arc shape bulging outwardly in a radial direction on an outer peripheral surface at a portion that is spaced apart by a predetermined interval from the head portion 10. The protruded portions 12a to 12d are formed integrally with the shaft portion 11.

The protruded portions 12a to 12d are formed over an entire perimeter about an axial line X1 of the shaft portion 11, and arranged at positions that are spaced apart from each other at a predetermined interval in a direction of the axial line X1. A portion other than the protruded portions 12a to 12d and the tip portion 14 of the shaft portion 11 has a predetermined outer diameter OD1, and a maximum outer diameter OD2 of the protruded portions 12a to 12d is greater than the outer diameter OD1 of the shaft portion 11 (OD1<OD2).

The tip portion 14 of the shaft portion 11 is provided with a groove (hereinafter, also referred to as a “slit”) 13 that is formed from a tip of the tip portion 14 towards the head portion 10 along the axial line X1. The tip portion 14 of the shaft portion 11 is divided in two by the slit 13, thus providing two parted portions 14a and 14b. It is to be noted that, among the four protruded portions 12a to 12d, although two protruded portions 12a, 12b that are closer to the tip portion 14 are divided in a direction of a perimeter by the presence of the slit 13, the divided protruded portions 12a and 12b are also considered as being “provided along an entire perimeter around the axial line X1”.

(Female Member)

As shown in FIGS. 3A and 3B, the female member 5 has a bottomed cylindrical shape, and the shaft portion 11 of the male member 1 is inserted therein. The female member 5 has, on an outer peripheral surface thereof, a plurality of inclined surfaces 51a that are formed obliquely at a predetermined angle with respect to the axial line X2 such that the inclined surfaces 51a come closer to the axial line X2 towards a bottom portion 52, and a plurality of vertical surfaces 51b formed perpendicularly to the axial line X2. That is to say, a plurality of stepped portions are formed on an outer peripheral surface of the female member 5 along the axial line X2 by the plurality of inclined surfaces 51a and the plurality of vertical surfaces 51b.

The female member 5 has, on an inner peripheral surface thereof, an insertion hole 53 whereto the shaft portion 11 of the male member 1 is inserted. The insertion hole 53 has an inner diameter ID1 that is slightly greater than the outer diameter OD1 of the shaft portion 11 (OD1<ID1).

At the insertion hole 53, an inclined surface 54a that is inclined to gradually become farther from the axial line X2 in an upward direction is formed at an upper opening end opposite the bottom portion 52. The inclined surface 54a serves as a guiding section 54 that guides the shaft portion 11 of the male member 1 towards the bottom portion 52 when inserting the male member 1 to the insertion hole 53 of the female member 5. The guiding section 54 is formed to have a shape of a substantially circular truncated cone centered on the axial line X2.

Further, an inner surface of the female member 5 defining the insertion hole 53 (hereinafter, also referred to as an “inner peripheral surface”) is provided with a plurality of recessed portions 55a to 55c that are recessed in a radial direction and formed in an arc shape in a cross-section taken along the axial line X2. The recessed portions 55a to 55c are provided on an entire perimeter around the axial line X2. The recessed portions 55a to 55c are disposed at positions that are spaced apart from each other at a predetermined interval along the axial line X2 direction. The interval between the recessed portions 55a to 55c is the same as the interval between the protruded portions 12a to 12d of the shaft portion 11.

A maximum inner diameter ID2 of the recessed portions 55a to 55c is greater than the inner diameter ID1 of the insertion hole 53 (ID2>ID1). It is preferable that the maximum inner diameter ID2 of the recessed portions 55a to 55c be about the same size as or less than the maximum outer diameter OD2 of the protruded portions 12a to 12d of the shaft portion 11 (ID2≦OD2). However, it is not limited thereto, and the maximum inner diameter ID2 of the recessed portions 55a to 55c may be about the same size as or greater than the maximum outer diameter OD2 of the protruded portions 12a to 12d of the shaft portion 11 (ID2≧OD2). When the male member 1 and the female member 5 are in a joined state, the recessed portions 55a to 55c correspond with the protruded portions 12a to 12c of the shaft portion 11. The recessed portions 55a to 55c and the protruded portions 12a to 12c are portions that come into surface contact with each other. The recessed portions 55a to 55c of the female member 5 serve as an engaging section 55 that engages with the protruded portions 12a to 12c of the shaft portion 11 of the male member 1.

Near the bottom portion 52 of the female member 5, an inner peripheral surface 56a having an inner diameter that is the same as the maximum inner diameter ID2 of the recessed portions 55a to 55c is provided continuously with the recessed portion 55a. The inner peripheral surface 56a serves as an accommodating section 56 in which the tip portion 14 of the shaft portion 11 of the male member 1 is inserted and accommodated.

The shaft portion 11 of the male member 1 is inserted from the guiding section 54 of the female member 5, and inserted and fitted to the engaging section 55 and the accommodating section 56. That is, the guiding section 54, the engaging section 55 and the accommodating section 56 of the female member 5 serve as a mating portion whereto the shaft portion 11 of the female member 5 is inserted and fitted.

At the bottom portion 52 of the female member 5, a columnar projecting pin 57 projecting towards the guiding section 54 side is formed integrally with the bottom portion 52 at a center of the bottom portion 52. The projecting pin 57 serving as a protrusion has a columnar part 57a having a fixed diameter and a tapered portion 57b having a diameter which gradually decreases from a tip side of the columnar part 57a.

The projecting pin 57 has a certain length that reaches the recessed portion 55a, but is formed shorter than a depth of the slit 13 in the tip portion 14 of the shaft portion 11 of the male member 1. However, it is not limited thereto, and the length of the projecting pin 57 may be modified depending on the depth of the slit 13. The columnar part 57a of the projecting pin 57 has a diameter D that is the same as or slightly greater than the width W of slit 13 (W≦D).

[Joining of Male Member and Female Member]

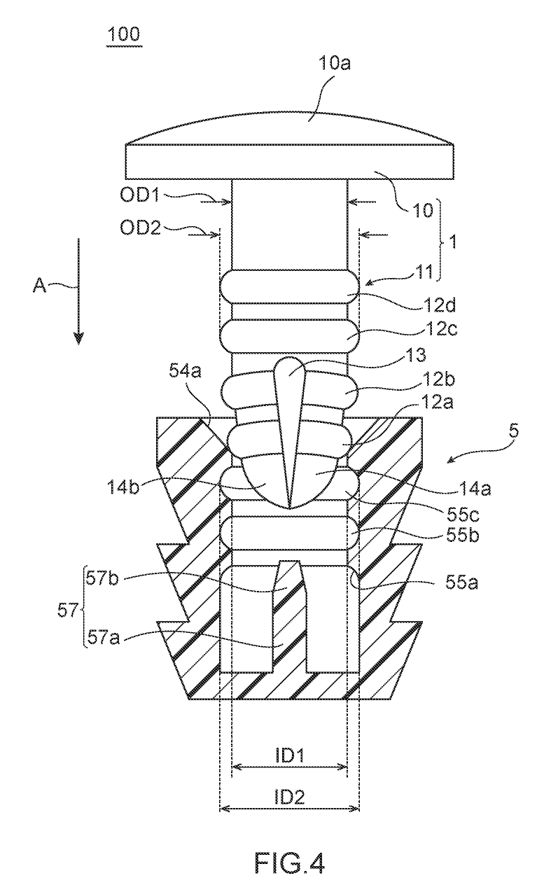

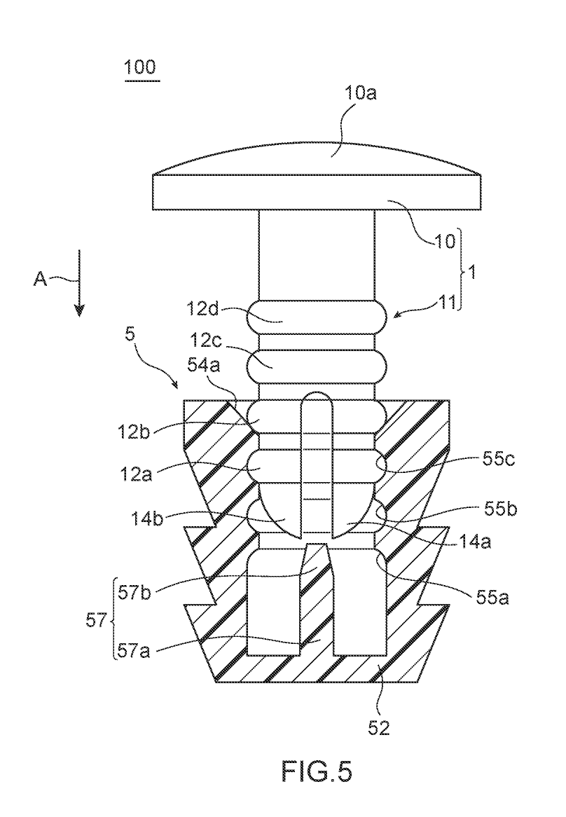

Now, an operation of joining the male member 1 and the female member 5 will be described with reference to FIG. 1 and FIGS. 4 to 6. FIG. 1 shows a state before insertion of the male member 1 into the female member 5. FIG. 4 is a diagram showing a state where the tip portion 14 of the male member 1 is inserted into the female member 5. FIG. 5 is a diagram showing a state where the male member 1 is partially engaged with the female member 5. FIG. 6 is a diagram showing a state where the male member 1 and the female member 5 are completely joined (joined state).

Regarding the joining device 100, when joining the male member 1 to the female member 5 as shown in FIG. 1, the shaft portion 11 of the male member 1 is inserted into the female member 5 along an insertion direction A, i.e., the axial lines X1 and X2.

When the male member 1 is inserted into the female member 5 along the insertion direction A, as shown in FIG. 4, at first, the protruded portion 12a provided at the most distal part of the shaft portion 11 comes into contact with the inclined surface 54a of the guiding section 54. Even if the male member 1 is inserted into the female member 5 in a state where the axial line X1 of the male member 1 does not match the axial line X2 of the female member 5, the shaft portion 11 is inserted with the protruded portion 12a being in contact with the inclined surface 54a of the guiding section 54. Thus, the male member 1 is inserted into the female member 5, while a deviation with respect to the axial line X2 of the female member 5 is being absorbed, and the male member 1 becomes centered with respect to the female member 5.

While being centered, the male member 1 is deformed such that the two parted portions 14a and 14b approach each other so that the slit 13 closes at a tip of the male member 1. Thus, regarding the shaft portion 11, the maximum outer diameter OD2 at the protruded portions 12a and 12b becomes closer to the inner diameter ID1 of the insertion hole 53, and thus insertion of the male member 1 to the female member 5 becomes smooth and facilitated.

In the insertion direction A, when the male member 1 is further inserted, the protruded portion 12a at the most distal tip side of the shaft portion 11 engages the recessed portion 55c of the mating portion as shown in FIG. 5. Here, since the maximum outer diameter OD2 of the protruded portions 12a to 12d is about the same size as the maximum inner diameter ID2 of the recessed portions 55a to 55c, the parted portion 14a, 14b of the shaft portion 11 which have been elastically deformed are restored to an original state. In this state, the slit 13 of the shaft portion 11 is opposing the projecting pin 57 of the female member 5.

In the insertion direction A, when the male member 1 is further inserted, the projecting pin 57 is inserted into the slit 13 of the shaft portion 11 as shown in FIG. 6. As the projecting pin 57 is inserted into the slit 13, the tapered portion 57b and subsequently the columnar part 57a of the projecting pin 57 are inserted into the slit 13. When the male member 1 is further inserted, the protruded portion 12a closest the tip side of the shaft portion 11 engages the recessed portion 55a, the protruded portion 12b engages the recessed portion 55b, the protruded portion 12c engages the recessed portion 55c, and the protruded portion 12d comes into contact with the inclined surface 54a of the guiding section 54.

Since the width W of the slit 13 is smaller than the diameter D of the columnar part 57a of the projecting pin 57 (W<D), an interference fit is created between the slit 13 and the columnar part 57a. Further, since the parted portions 14a and 14b of the shaft portion 11 are pushed out towards the inner peripheral surface of the female member 5, an engaged condition between the protruded portions 12a and 12b of the tip side of the shaft portion 11 and the recessed portions 55a and 55b becomes stronger.

Further, since the protruded portions 12a to 12d of the shaft portion 11 and the recessed portions 55a to 55c of the male member 1 the female member 5 are both formed with an arc shape, an insertion operation of the male member 1 to the female member 5 is facilitated. Further, with the joining device 100, since the male member 1 can be joined with the female member 5 or withdrawn from the female member 5 while an engaged condition between the recessed portions 55a to 55c of the shaft portion 11 of the male member 1 and the protruded portions 12a to 12d of the female member 5 is fitted or released step-by-step, neither the male member 1 nor the female member 5 is damaged while being joined or being withdrawn.

Further, since two or more of the protruded portions 12a to 12d of the shaft portion 11 and two or more of the recessed portions 55a to 55c of the female member 5 are provided along the axial lines X1 and X2, the joined state between the male member 1 and the female member 5 can be made stronger, and the joined state can be prevented from being released easily.

Rather than a case in which the female member 5 and the male member 1 are engaged at a single location between the protruded portion 12a and the recessed portion 55c, the joining force increases exponentially when engaged at two parts between the protruded portions 12a and 12b and the recessed portions 55c and 55b, respectively, or when engaged at three parts between the protruded portions 12a to 12c and the recessed portions 55c to 55a, respectively.

### Second Embodiment

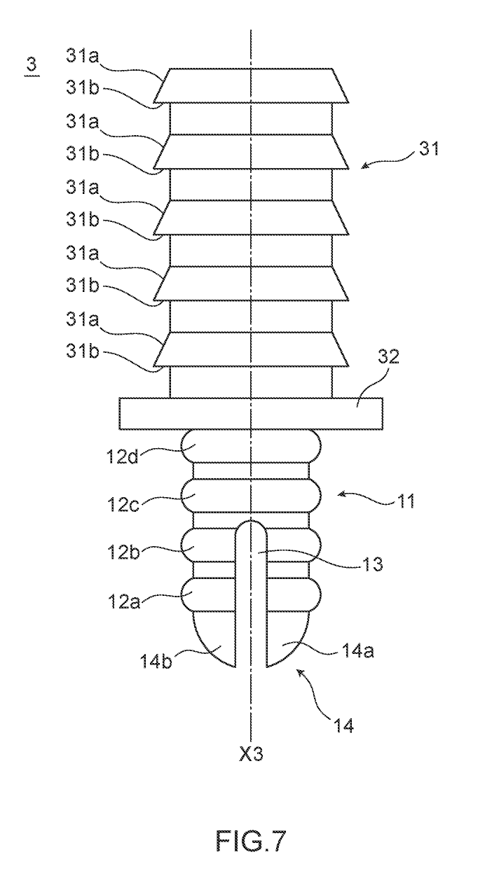

Now, a joining device 200 according to a second embodiment will be described with reference to FIG. 7. Hereinafter, only those parts that are different from the configuration of the first embodiment will be described, and parts that are the same as those of the first embodiment will be given the same reference numerals, and will not be described in detail. FIG. 7 is a side view of the male member 3 according to the second embodiment. It is to be noted that a joining device 200 includes a male member 3 shown in FIG. 7, in place of the male member 1 of the first embodiment, and the female member 5 of the first embodiment. The female member 5 will not be described here, since it has a configuration which is the same as the first embodiment.

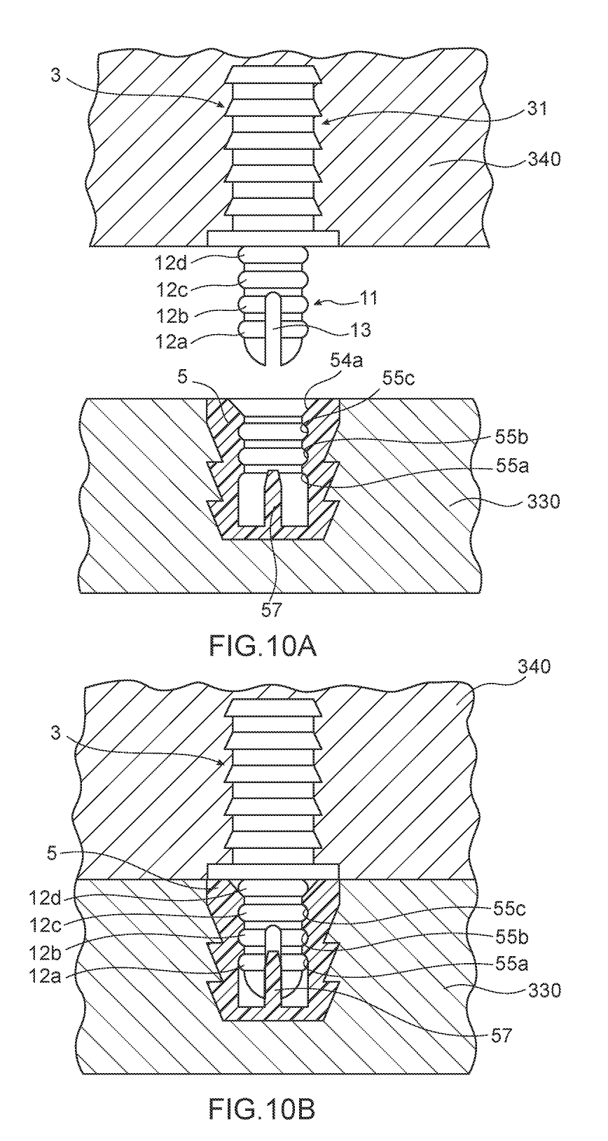

The male member 3 of the joining device 200 has the shaft portion 11 lying along art axial line X3 and a columnar portion 31 having a diameter greater than that of the shaft portion 11. The columnar portion 31 has a flange 32 having a diameter greater than that of the columnar portion 31, and the flange 32 is provided between the columnar portion 31 and the shaft portion 11. The columnar portion 31 is fitted in one member (shelf board 340 shown in FIG. 10) of two boards to be assembled with each other using the joining device 200.

An outer peripheral surface of the columnar portion 31 has inclined surfaces 31a that are provided obliquely at a predetermined angle with respect to the axial line X3 such that the inclined surfaces 31a come closer to the axial line X3 towards a direction opposite the shaft portion 11, and vertical surfaces 31b formed perpendicularly to the axial line X3. That is to say, a plurality of stepped portions are formed on an outer peripheral surface of the columnar portion 31 along the axial line X3 by the plurality of inclined surfaces 31a and the plurality of vertical surfaces 31b.

It is to be noted that, similarly to the male member 1 of the first embodiment, the male member 3 has a plurality of the protruded portions 12a to 12d formed integrally with the shaft portion 11. Since the protruded portions 12a to 12d have the same configuration as the male member 1, the description is omitted here.

<Example of Application of Joining Device 100 and Joining Device 200>

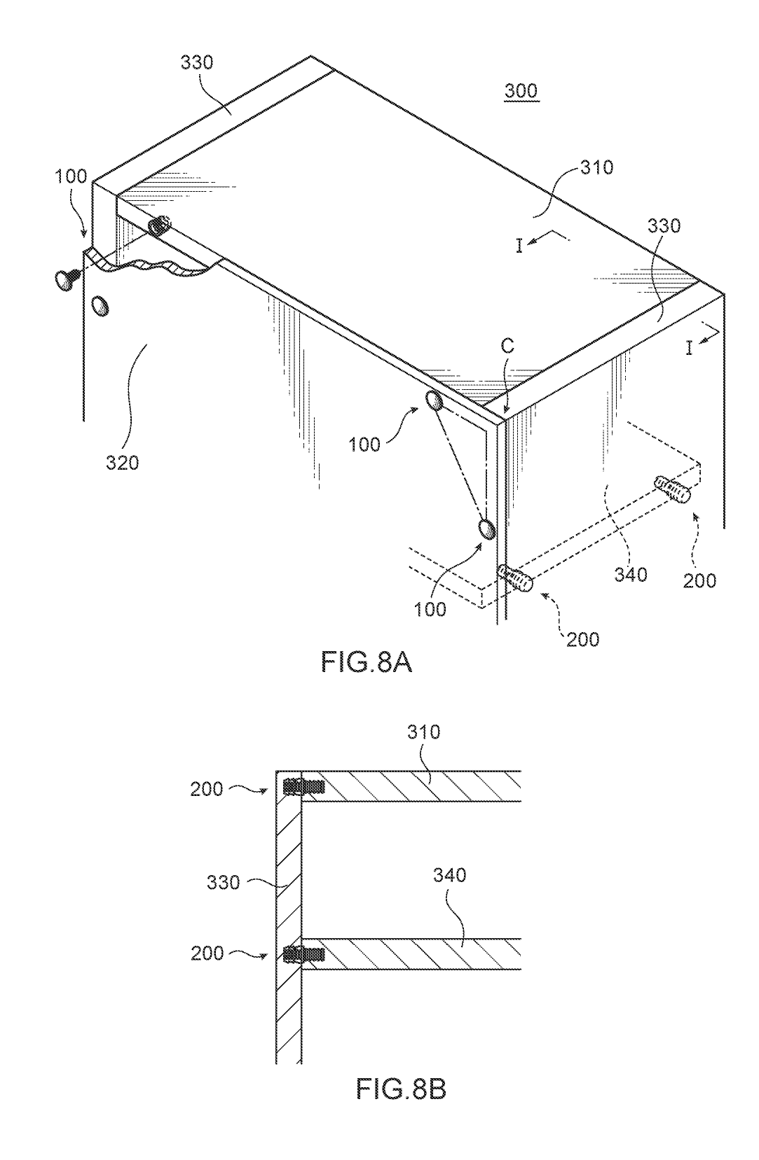

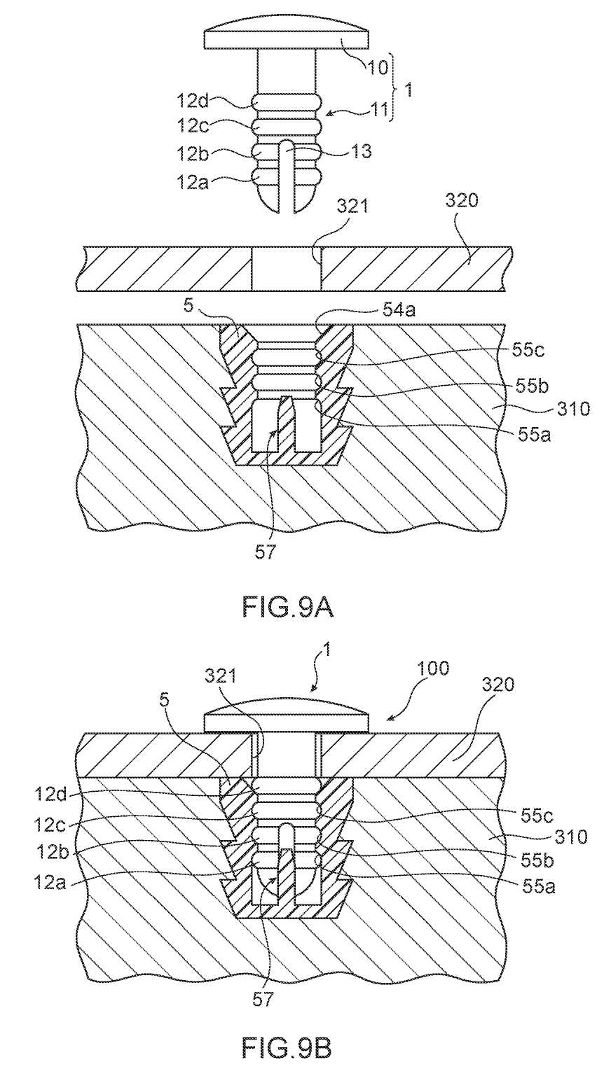

With reference to FIG. 8A to FIG. 10, a specific example in which the joining devices 100 and 200 according to the first and second embodiments are applied to an assembled structure 300 will be described. FIGS. 8A and 8B are schematic diagrams of the assembled structure 300 including joining devices 100 and 200 according to the first and second embodiments. FIG. 8A is a schematic perspective view of the assembled structure 300 viewed at an angle from the rear. FIG. 8B is a cross-sectional view of the assembled structure 300 taken along line I-I in FIG. 8A. FIGS. 9A and 9B are explanatory diagrams of a joining operation using the joining device 100 according to the first embodiment. FIG. 9A is a cross-sectional view showing a state before joining two assembly components 310 and 320. FIG. 9B is a cross-sectional view showing a state after joining one assembly component 310 with another assembly component 320. FIGS. 10A and 10B are explanatory diagrams of a joining operation using the joining device 200 according to the second embodiment. FIG. 10A is a cross-sectional view showing a state before joining two assembly components 330 and 340. FIG. 10B is a cross-sectional view showing a state after joining one assembly component 330 with another assembly component 340.

For example, in a case where the assembled structure 300 is a shelf, which is presented as an exemplary ready-to-assemble furniture, a plurality of boards (assembly components) 310, 320, 330, and 340 are assembled and joined with each other as shown in FIGS. 8A and 8B.

Specifically, the assembled structure 300 is provided with a top board 310, a base board (not shown), a back board 320, side boards 330, 330 and a shelf board 340. The back board 320 is joined to end faces of longer sides of the top board 310 and the base board. The side boards 330, 330 are joined to side end faces at both side of shorter sides of the top board 310 and the base board. The shelf board 340 is joined between the side boards 330 and 330. It is to be noted that a joining process described below does not necessarily correspond with an actual assembly procedure of the assembled structure 300.

At first, referring to FIGS. 9A and 9B, a joining process of the top board 310 and the back board 320 will be described. Here, the female member 5 is embedded and fixed in advance in the top board 310, and the inclined surface 54a of the guiding section 54 is exposed at the surface.

An insertion hole 321 through which the shaft portion 11 of the male member 1 is inserted is formed at a position matching the female member 5 of the top board 310 when the back board 320 and the top board 310 are assembled. The diameter of the insertion hole 321 is slightly greater than the maximum outer diameter OD2 of the protruded portions 12a to 12d of the shaft portion 11, but smaller than the diameter of the head portion 10.

With the insertion hole 321 of the back board 320 being made to correspond to the female member 5 fitted in the top board 310, the male member 1 is inserted into a mating portion (guiding section 54, engaging section 55, accommodating section 56) of the female member 5 until the head portion 10 of the male member 1 abuts the back board 320. Thus, the top board 310 and the back board 320 can be joined easily, quickly and firmly without using a tool.

Also, during the insertion, since the protruded portions 12a to 12d of the shaft portion 11 of the male member 1 engage the recessed portions 55a to 55c of the mating portion of the female member 5 in a step-by-step manner, assembling staff can feel the step-by-step engagement of the protruded portions 12a to 12d and the recessed portions 55a to 55c. Thereby, the assembling staff can intuitively recognize that engagement between the male member 1 and the female member 5 is completed.

Note that, as shown in FIG. 8A, the joining device 100 is also used in joining the back board 320 and the side board 330. A position whereto the joining device 100 is attached when joining the back board 320 and the side board 330 is not particularly limited. However, considering the durability and vibration proof property of the assembled structure 300, it is preferable that a triangle formed by connecting a corner C and two joining devices 100 disposed in the vicinity of the corner C and across the corner C with imaginary dash-dot lines is a right angled triangle.

Referring now to FIGS. 10A and 10B, a joining process of the side board 330 and the shelf board 340 will be described. The female member 5 is embedded and fixed in advance in the side board 330, and the columnar portion 31 of the male member 3 is embedded and fixed in advance in shelf board 340.

Of the male member 3 embedded in the shelf board 340, the shaft portion 11 exposed from shelf board 330 is inserted into the mating portion of the female member 5 until the side board 330 and the shelf board 340 abut each other. With such a simple operation, the side board 330 and the shelf board 340 can be joined firmly and quickly. Note that, as shown in FIG. 8B, the joining device 200 is also used for joining the top board 310 and the side board 330. Also, the male member 3 may be embedded in the side board 330, and the female member 5 may be embedded in the top board 310 or the shelf board 340.

Note that, regarding the male member 1, the joining state between the back board 320 and the side board 330 can be easily released by an operator by, for example, simply gripping and pulling out the head portion 10 from the female member 5. Here, since it is only the fitted state between the protruded portions 12a to 12d of the shaft portion 11 of the male member 1 and the recessed portions 55a to 55c of the female member 5 that is released, the male member 1 and the female member 5 are not damaged.

The female member 5 is fixed to the side board 330. Accordingly, the fitted state between the protruded portion 12a to 12d of the shaft portion 11 of the male member 3 and the recessed portion 55a to 55c of the female member 5 is released by an operator simply pulling the side board 330 apart from the shelf board 340. Thus, the joined state between the side board 330 and the shelf board 340 can be easily released. Also, in this case, the male member 3 and the female member 5 are not damaged.

When pulling out the male member 1, 3, the female member 5 has its vertical surface 51b caught by the side board 330, and thus the side board 330 can be prevented from being broken by being pulled out along when the male member 1, 3 are pulled out.

### Other Embodiments

As for the joining devices 100 and 200 according to first and second embodiments, the male member 1, 3 is provided with the slit 13, and the female member 5 is provided with the projecting pin 57, but it is not limited thereto. For example, as long as a desired joined state is accomplished by a mutual strong engaging force between the male member 1, 3 and the female member 5 of the joining device 100, 200, the joining device may be provided with a male member without a slit 13 and a female member without a projecting pin 57.

The present disclosure is not limited to the first and second embodiments. For example, the joining device 100 according to the first embodiment may be used for joining the side board 330 and the shelf board 340, and the joining device 200 according to the second embodiment may be used for joining the top board 310 and the back board 320. Note that, for example, the manner of assembling the boards, specifically, the top board 310 and the side boards 330, 330 is not limited to what is described above, and the top board 310 may be assembled by being placed on top of the side boards 330, 330.

In the first and second embodiment, the male member 1, 3 has four protruded portions 12a to 12d, and the female member 5 has three recessed portions 55a to 55c, but it is not limited thereto. The number of the protruded portions and the recessed portions may be modified as required, respectively, and, for example, the same number of protruded portions and the recessed portions may be provided, or the number of recessed portion may be greater than the number of protruded portions.

Further, the cross-sectional shape of the protruded portions 12a to 12d along the axial line X1 of the shaft portion 11 is not limited to an arc shape, and may be other shapes such as a rectangular or triangle shape, and the design of the shape of the recessed portions 55a to 55c may be appropriately modified accordingly. Also, the protruded portion 12a may not be formed over an entire perimeter, but may be provided as a plurality of hemispherical protrusions independently provided in the direction of the perimeter.

The shaft portion 11 of the male member 1, 3 is not limited to a columnar shape, and may be form of prism, and not particularly limited. Also, the projecting pin 57 is not limited to a columnar shape, and may be a conical shape, a rectangular prism or rectangular conical shape, and not particularly limited.

The assembled structure 300 is not limited to a shelf as long as it includes at least two assembly components that are joined, and may be other various assembly structures such as drawers, a dressing table, a cupboard, a book shelf, a desk, a chair, a table, a bed, a chest, a television support, an audio rack, a loud speaker support, a personal computer rack, etc.

What is claimed is:

1. A joining device comprising:
a male member including a shaft portion; and
a female member including a mating portion whereto the shaft portion is inserted and fitted, the female member having a bottomed tubular shape,
the male member and the female member being capable of being detachably joined with each other,
the shaft portion including a plurality of protruded portions on an outer surface thereof along an axial line direction and a slit at a tip portion in a direction of insertion into the mating portion, each protruded portion of the plurality of protruded portions having an arc shape in a cross section taken along the axial line direction and being protruded over an entire perimeter about an axial line of the shaft portion, the slit lying along the axial line,
the mating portion having a plurality of recessed portions on an inner surface thereof along an axial line direction and a bottom portion configured to close the mating portion, each recessed portion of the plurality of recessed portions having an arc shape in a cross section taken along the axial line direction and being recessed over an entire perimeter about an axial line of the mating portion, the bottom portion having a rod-like projected portion projecting in a direction opposite to the direction of insertion and capable of being inserted into the slit,
the slit having a length that divides the protruded portion provided on a side of the tip portion of the shaft portion along the axial line direction,
the projected portion having a length that reaches the recessed portion provided at a position closest to the bottom portion among the plurality of recessed portions,
wherein the shaft portion and the mating portion are capable of being joined by being engaged at the plurality of protruded portions and the plurality of recessed portions, an interference fit being created between the slit and the projected portion.

2. The joining device according to claim 1, wherein
the plurality of protruded portions are spaced apart from each other in the axial line direction of the shaft portion by a predetermined interval, and
the plurality of recessed portions are spaced apart from each other in the axial line direction of the mating portion by a predetermined interval.

3. The joining device according to claim 1, wherein
the projected portion has a columnar portion formed integrally with the bottom portion and creating an interference fit with the slit, and a tapered portion formed integrally on a tip side of the columnar portion.

4. An assembled structure comprising:
a first assembly component;
a second assembly component; and
a male member including a shaft portion and a female member including an mating portion whereto the shaft portion is inserted and fitted, the male member and the female member being capable of being detachably joined with each other,
the first and second assembly components being capable of being assembled by being joined with each other,
the shaft portion including a plurality of protruded portions on an outer surface thereof along an axial line direction and a slit at a tip portion in a direction of insertion into the mating portion, each protruded portion of the plurality of protruded portions having an arc shape in a cross section taken along the axial line direction and being protruded over an entire perimeter about an axial line of the shaft portion, the slit lying along the axial line,
the mating portion having a plurality of recessed portions on an inner surface thereof along an axial line direction and a bottom portion configured to close the mating portion, each recessed portion of the plurality of recessed portions having an arc shape in a cross section taken along a direction of the axial line and recessed over an entire perimeter about an axial line of the mating portion, the bottom portion having a rod-like projected portion projecting in a direction opposite to the direction of insertion and capable of being inserted into the slit,
the slit having a length that divides the protruded portion provided on a side of the tip portion side of the shaft portion along the axial line direction,
the projected portion having a length that reaches the recessed portion provided at a position closest to the bottom portion among the plurality of recessed portions,
the female member being attached to one of the first assembly component and the second assembly component,
the male member being attached to one of the second assembly component and the first assembly component,
the first and second assembly components being joined with each other by engagement of the shaft portion of the male member and the mating portion of the female member at the plurality of protruded portions and the plurality of recessed portions, an interference fit being created between the slit and the projected portion.
